(19) United States
(12) Patent Application Publication
(10) Pub. No.: US 2025/0334795 A1
(43) Pub. Date: Oct. 30, 2025

(54) IMAGING APPARATUS

(71) Applicant: DENSO CORPORATION, Kariya-city (JP)

(72) Inventor: Kohei KUNO, Kariya-city (JP)

(21) Appl. No.: 19/188,891

(22) Filed: Apr. 24, 2025

(30) Foreign Application Priority Data
Apr. 26, 2024 (JP) 2024-073226

(51) Int. Cl. G02B 27/00; B60S 1/08; B60S 1/26; B60S 1/56

(52) U.S. Cl. CPC G02B 27/0006; B60S 1/08; B60S 1/26; B60S 1/56

(57) ABSTRACT

An imaging apparatus includes a receptacle, a lens that is received in the receptacle and has one surface exposed to an exterior of the receptacle as an exposed surface to capture light from the exterior of the receptacle, an imager that is disposed within the receptacle and inward from the lens and is configured to capture images of the exterior of the receptacle based on light captured by the lens, an imager substrate that is disposed within the receptacle and inward from the lens and is configured to control the imager, a wiper device that includes at least one lens wiper to wipe the exposed surface of the lens. Each of the at least one lens wiper includes a wiping member that includes a wiper rubber and a wiper blade, and the wiping member is positioned on the exposed surface of the lens in a standby mode, in which mode driving of the wiper device is suspended, thereby partially obstructing the light incident on the lens.

### CROSS-REFERENCE TO RELATED APPLICATION

This application is based on and claims the benefit of priority from earlier Japanese Patent Application No. 2024-073226 filed Apr. 26, 2024, the description of which is incorporated herein by reference.

### BACKGROUND

### Technical Field

This disclosure relates to an imaging apparatus, particularly suitable for application to an on-board camera device or a stereo camera for Light Detection and Ranging (LiDAR).

### Related Art

Conventionally, an imaging apparatus equipped with a wiper is known. In the known imaging apparatus having a structure in which a lens and a lens barrel surrounding the lens are held by a housing, a wiper is provided at a position above the lens so as not to cover the lens, and the wiper is swingable around an axis of rotation disposed outside the lens barrel.

### BRIEF DESCRIPTION OF THE DRAWINGS

In the accompanying drawings:

FIG. 1 is a block diagram of a camera system to which a camera device according to a first embodiment is applied;

FIG. 2 is a perspective view of the camera device according to the first embodiment;

FIG. 3 is a front view of the camera device illustrated in FIG. 1;

FIG. 4 is a cross-sectional view of the camera device taken along line IV-IV in FIG. 3;

FIG. 5 is a cross-sectional view of the camera device taken along line V-V in FIG. 3;

FIG. 6 is an exploded view of the camera device illustrated in FIG. 2;

FIG. 7 is an illustration of a positional relationship between a range of motion of a lens wiper and an imager;

FIG. 8 is a perspective view of a camera device according to a second embodiment;

FIG. 9 is a front view of the camera device illustrated in FIG. 8;

FIG. 10 is a cross-sectional view taken along line X-X of FIG. 9;

FIG. 11 is a cross-sectional view taken along line XI-XI of FIG. 9;

FIG. 12 is a cross-sectional view taken along line XII-XII of FIG. 9;

FIG. 13 is an exploded view of the camera device illustrated in FIG. 8;

FIG. 14 is an illustration of wiping members in a standby mode and replacement of the parts of the wiper in a replacement mode;

FIG. 15 is a perspective view of a camera device according to a third embodiment;

FIG. 16 is a front view of the camera device illustrated in FIG. 15;

FIG. 17 is a cross-sectional view taken along line XVII-XVII of FIG. 16;

FIG. 18 is a cross-sectional view taken along line XVIII-XVIII of FIG. 16; and

FIG. 19 is an exploded view of the camera device illustrated in FIG. 15.

### DESCRIPTION OF SPECIFIC EMBODIMENTS

When the imaging apparatus is used outdoors, for example, when the camera device is installed outside a vehicle cabin as an on-board imaging apparatus, a wiper needs to be provided to address an issue of foreign matter such as raindrops adhering to the lens. However, in a downsized imaging apparatus, there is no space to mount a wiper, and there is an issue of downsizing the wiper and making it inconspicuous from the viewpoint of design. Thus, in the known imaging apparatus, as disclosed in JP 2007-53448 A, the structure in which the wiper is installed outside the lens and the lens barrel leads to a larger and more costly imaging apparatus.

In the known imaging apparatus disclosed in JP 2007-53448 A, the wiper is not in contact with the lens in the standby mode, and when wiping off deposits on the lens surface, the wiper straddles the boundary between the lens and the lens barrel. Thus, a wiper rubber fails to reach the bottom of a recess arising from a step at the boundary between the lens and the lens barrel, and the lens fails to be wiped adequately. To address such an issue, a cover glass covering the lens and the lens barrel may be provided to eliminate the step. However, the waterproofing structure becomes more complicated when such a cover glass is provided, resulting in a larger size and higher cost.

In view of the foregoing, it is desired to have an imaging apparatus capable of adequately wiping off deposits on the lens surface while suppressing the increase in size of the imaging apparatus.

One aspect of the present disclosure provides an imaging apparatus including: a receptacle; a lens that is received in the receptacle and has one surface exposed to an exterior of the receptacle as an exposed surface to capture light from the exterior of the receptacle; an imager that is disposed within the receptacle and inward from the lens and is configured to capture images of the exterior of the receptacle based on light captured by the lens; an imager substrate that is disposed within the receptacle and inward from the lens and is configured to control the imager; a wiper device that includes at least one lens wiper to wipe the exposed surface of the lens. Each of the at least one lens wiper includes a wiping member that includes a wiper rubber and a wiper blade, and the wiping member is positioned on the exposed surface of the lens in a standby mode, in which mode driving of the wiper device is suspended, thereby partially obstructing the light incident on the lens.

In the above configuration, the wiping member of the lens wiper is disposed in front of the lens, allowing the lens wiper to wipe the surface of the lens. Therefore, the lens wiper can even out or remove raindrops or other foreign matter on the surface of the lens. Even in the standby mode of the lens wiper, the wiping member is positioned on the exposed surface of the lens to obstruct light from entering the lens. Therefore, the wiping member can wipe the lens surface adequately without straddling the boundary between the lens and the lens fixture. Since front surfaces of the lens and the lens fixture are not covered with a cover glass to be flushed with each other, it is possible to suppress increases in size and cost. Therefore, there is provided an imaging apparatus capable of adequately wiping off foreign matter on the lens surface while suppressing increases in size of the imaging apparatus.

Hereinafter, embodiments of the present disclosure will be described with reference to the accompanying drawings. In the following embodiments, the same or equivalent parts are assigned the same reference numbers in the drawings, and the same description is adopted for parts with the same reference numbers.

### First Embodiment

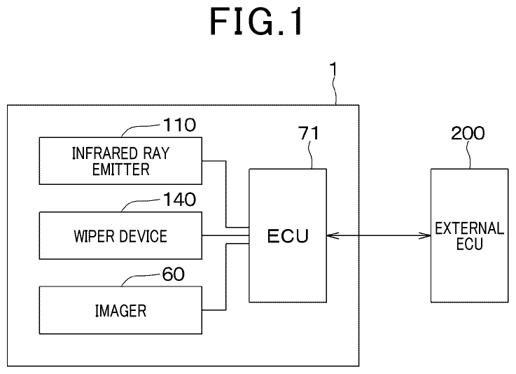

The first embodiment of the present disclosure will now be described. In the present embodiment, the imaging apparatus will be described using a camera device as an example. This camera device is an on-board camera device that is applied, for example, to capture images of the surroundings of a vehicle. For example, a camera device 1 is applied in a camera system configured as illustrated in FIG. 1, and is controlled by communicating with an external electronic control unit (ECU) 200 mounted to the vehicle.

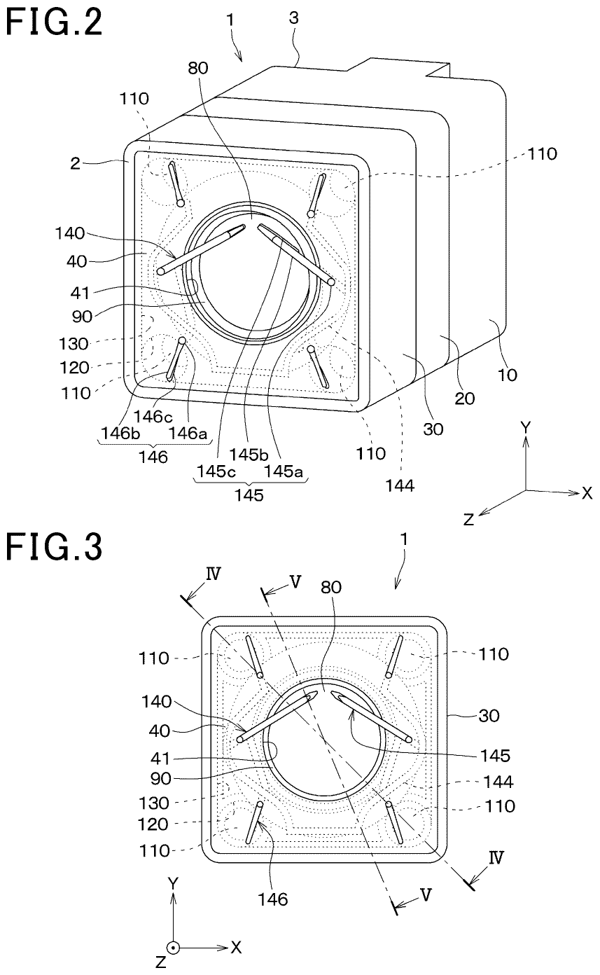

For purposes of illustration, the X-axis, Y-axis and Z-axis are indicated in the accompanying drawings. As illustrated in FIG. 2, X-axis and Y-axis are defined as directions in the front end surface of the camera device 1 and as directions perpendicular to one another, and the direction perpendicular to X-axis and Y-axis is referred to as Z-axis. In the Z-axis direction, the end of the camera device 1 where imaging is performed is referred to as the front end, and the end on the opposite side is referred to as the rear end.

As illustrated in FIGS. 2 to 6, the camera device 1 includes a cover 10, a case 20, a head 30, a guide 40, a lens barrel 50, an imager 60, an imager substrate 70, a lens 80, a lens fixture 90, optical components 100, an infrared ray emitter 110, an LED substrate 120, a rubber seal 130, and a wiper device 140.

The cover 10 is a constituent of the receptacle of the camera device 1, and is configured to be a part on the rear end 3 side of the receptacle, opposite from the front end 2 side where the guide 40 is disposed. The cover 10 has a rectangular outline shape as viewed from the Z-axis direction, with two sides along the X-axis and two sides along the Y-axis, and has a substantially bottomed rectangular cylindrical shape with an opening on the case 20 side, with the inside being a hollow 11. The material of the cover 10 may be, but is not limited to, a resin. An opening 13 is formed in the center of the bottom 12 of the cover 10. In the hollow 11, the shield member 14 is disposed along the inner wall of the cover 10, and portions of the shield member 14 and the terminal 15 fit within the opening 13, with the terminal 15 protruding out of the cover 10. In addition, a connector 16 is formed as a portion of the cover 10 so that it protrudes from the bottom 12 towards the exterior of the camera device 1. When this connector 16 is connected to another connector (not shown), power is supplied to the camera device 1 and the image data captured by the camera device 1 is output to the external ECU 200.

The hollow 11 of the cover 10 receives a portion of the lens barrel 50, the imager 60, and the imager substrate 70. The imager 60 and the imager substrate 70 are surrounded by the shield member 14, which suppresses transmission of external noise to the imager 60 and the imager substrate 70.

A case 20 is a constituent of the receptacle of the camera device 1. As viewed from the Z-axis direction, it has a rectangular outline shape with two sides along the X-axis and two sides along the Y-axis, and it has a substantially rectangular cylindrical shape with a hollow 21 that extends through the interior along the Z-axis. The case 20 may be made of any material, but for example, may be made of a resin. The case 20 receives a portion of the lens barrel 50 and some of the optical components 100 within the hollow 21.

At the cover 10 side end of the case 20, an engagement protrusion 24 is formed with slightly smaller external dimensions than the other portions, and the case 20 and cover 10 are integrated by this engagement protrusion 24 fitting inside the hollow 11 of the cover 10. The outline shapes of the case 20 and the cover 10 are matched. That is, the outer dimensions of the substantially rectangular shapes of the case 20 and the cover 10 are matched, so that the surfaces of the case 20 and the cover 10 that make up a respective side of the substantially rectangular shape share the same plane. The case 20 and the cover 10 are welded at their boundaries and are intimately mated with each other. The joining method is not limited to welding, but may be any other method such as adhesion or press fitting.

At the head 30 side end of the case 20, another engagement protrusion 25 is formed, and the case 20 and the head 30 are integrated and secured by this engagement protrusion 25 fitting inside the head 30 at the case 20 side end. The outline shapes of the case 20 and the head 30 are matched. That is, the outer dimensions of the substantially rectangular shapes of the case 20 and the head 30 are matched, so that the surfaces of the case 20 and the head 30 that make up a respective side of the substantially rectangular shape share the same plane. Thus, the surfaces of the cover 10, case 20 and head 30 are all in the same plane, and the overall shape of the receptacle for the camera device 1 that is composed of these parts is substantially rectangular.

The boundary between the case 20 and the head 30 is sealed with an adhesive or the like. Instead, welding may be performed at the boundary between the case 20 and the head 30. Of course, any other sealing method may be used instead of welding.

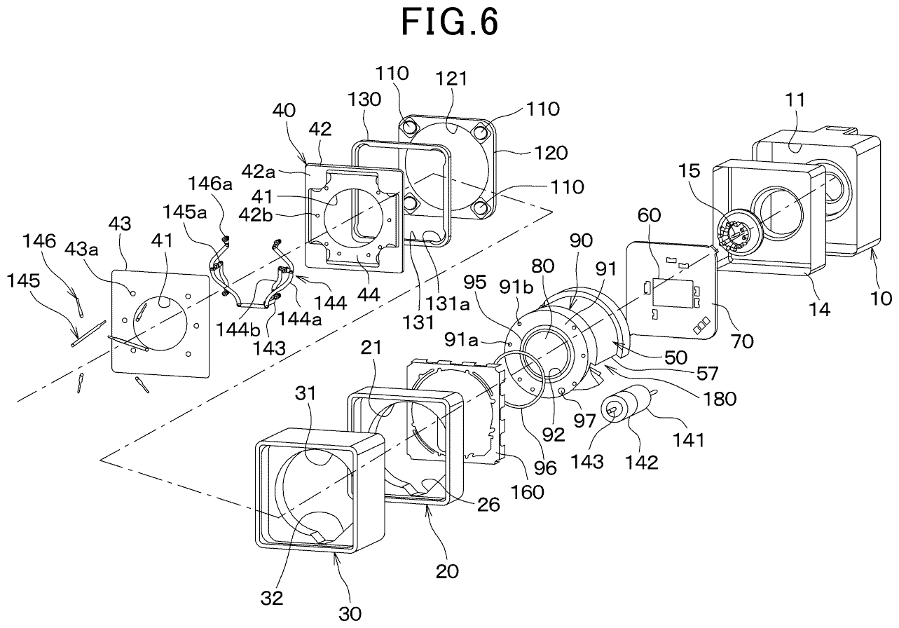

In addition, as illustrated in FIG. 6, a recess 26 extending along the Z-axis is formed in a portion of the inner wall of the case 20. This recess 26 receives a portion of the motor 141 and other components described later that are provided in the wiper device 140.

A head 30 is a constituent of the receptacle of the camera device 1. As viewed from the Z-axis direction, it has a rectangular outline shape with two sides along the X-axis and two sides along the Y-axis, and it is a substantially rectangular cylindrical shape with a hollow 31 that extends through the interior along the Z-axis. The head 30 may be made of any material, but for example, may be made of metal. The hollow 31 of the head 30 receives a portion of the lens barrel 50, some of the optical components 100, the lens 80, the infrared ray emitter 110, the LED substrate 120, the lens fixture 90, the rubber seal 130, and a portion of the wiper device 140. In addition, a guide 40 is disposed to fit within the hollow 31 at the front end 2 of the camera device 1 of the head 30. The guide 40, the lens 80, and the lens fixture 90, which includes the O-ring 96 described later, suppress intrusion of water into the hollow 31.

The hollow 31 of the head 30 has a multi-stepped shape along the Z-axis from the front end 2 side to the rear end 3 side. Thus, the dimension of the hollow 31, that is, the inner wall dimension of the head 30, is changed in steps. Specifically, the dimension of the hollow 31 is such that the first section 31a at the foremost end matches the outer dimension of the guide 40. A second section 31b rearward of the first section 31a has a smaller inner wall dimension than the first section 31a. The guide 40 is fitted inside the hollow 31 using the boundary between the first and second sections 31a and 31b as a seating surface, and is adhered thereto by an adhesive or other means. A third section 31c on the rear end 3 side of the second section 31b has a further reduced inner wall dimension of the hollow 31 to match the outer shape of the lens barrel 50 and the lens fixture 90. The LED substrate 120, the infrared ray emitters 110, and the rubber seal 130 are disposed in the hollow 31 and on a mounting surface at the boundary position between the second and third sections 31b and 31c. A portion of the lens barrel 50, a portion of the lens fixture 90 and some of the optical components 100 are disposed within the third section 31c.

Furthermore, as illustrated in FIG. 6, a recess 32 extending along the Z-axis is also formed in a portion of the inner wall of the head 30. This recess 32 is connected to the recess 26 of the case 20 and receives portions of the motor 141 and other components described later, which are provided in the wiper device 140.

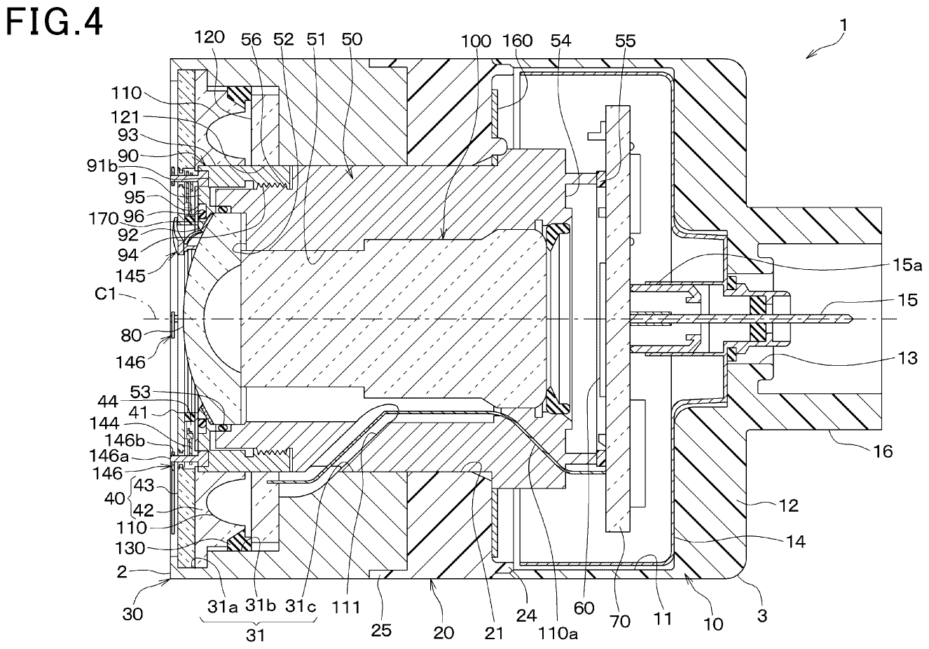

As illustrated in FIGS. 4 to 6, a metal grounding spring 160 is provided at the boundary between the cover 10 and the case 20. This grounding spring 160 prevents the lens barrel 50 from rattling against the case 20 and also prevents external noise from being transmitted to the imager 60 and the imager substrate 70.

The guide 40 is a plate-like member that protects functional components of the camera device 1 and is made of glass, acrylic resin, or the like. The guide 40 has a rectangular outline shape with two sides along the X-axis and two sides along the Y-axis, and is attached to the head 30 to prevent intrusion of water into the interior of the camera device 1 together with the lens 80 and lens fixture 90. An opening 41 is formed in the center of the guide 40, through which portions of the lens 80 and the lens fixture 90 are exposed.

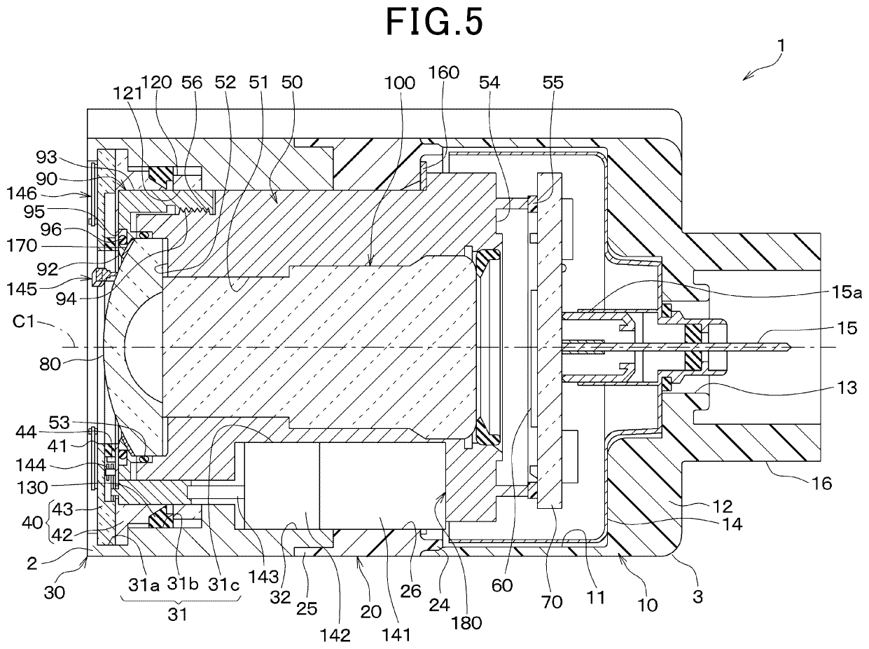

As illustrated in FIG. 5, the guide 40 is configured as a stack of a first guide member 42 and a second guide member 43. The first guide member 42 is made of a light guiding material that transmits visible and infrared light. The second guide member 43 is made of a material that transmits infrared light but blocks or attenuates visible light. Since visible light is blocked by the second guide member 43, the lighting of the internal light source is made inconspicuous from the outside while infrared light from the infrared ray emitter 110 is transmissive, thereby improving the appearance of the design.

A space 44 is configured between the first guide member 42 and the second guide member 43. Within the space 44, portions of the components constituting the wiper device 140 are received. An opening 41 is formed in each of the first guide member 42 and the second guide member 43, and a gap is provided between the first guide member 42 and the second guide member 43 outside the opening 41, and a space 44 is configured by the gap. Specifically, as illustrated in FIG. 6, the second guide member 43 is a rectangular flat plate member, and the end 2 side, that is, the side exposed to the exterior, is flat. The first guide member 42 is also a rectangular flat plate member, but has a convex portion 42a at its outer edge that protrudes toward the second guide member 43 in a frame shape. A space 44 is configured between the first guide member 42 and the second guide member 43 and inside the convex portion 42a.

The first guide member 42 has a plurality of through-holes 42b penetrating in the Z-axis direction around the opening 41. Similarly, the second guide member 43 has a plurality of through holes 43a penetrating in the Z-axis direction around the opening 41. Through these through holes 42b and through holes 43a, constituents of the wiper device 140, specifically shafts, can be disposed through the thickness of the guide 40.

The lens barrel 50 corresponds to a housing that conveys the light received by the lens 80 to the imager 60. The lens barrel 50 has a cylindrical shape, here a substantially cylindrical shape, having a hollow 51 extending through the lens barrel 50 along the Z-axis direction, and is made of metal, such as aluminium. The optical axis of the lens barrel 50 is parallel to the direction along the Z-axis, here the Z-axis.

The lens barrel 50 holds the lens 80 and other optical components 100 in a desired positional relationship, that is, a positional relationship in which the light is focused on the imager 60. Although not shown, within the hollow 51 of the lens barrel 50, a plurality of optical components 100 are disposed along the Z-axis and held by the inner wall surface of the lens barrel 50. On the front end 2 side of the lens barrel 50, a lens holder 52 is formed, which is recessed from the front end 2 side toward the rear end 3 side. The inner wall dimension of the lens holder 52 is larger than the inner wall dimension of the lens barrel 50 at the position where the optical components 100 are disposed. Disposing the lens 80 within this lens holder 52 allows the lens 80 to be in contact with the front end of the lens barrel 50. An O-ring 53 is disposed around the outer circumference of the lens 80 in the lens holder 52 of the lens barrel 50, sealing between the lens 80 and the lens barrel 50 and positioning the lens 80 in the XY plane.

A recess 54 in which the imager 60 is disposed is formed on the rear end 3 side of the lens barrel 50, and furthermore, the rear end 3 side of the lens barrel 50 is bonded to the imager substrate 70 via an adhesive material 55. In this manner, the lens 80 and the optical components 100 are positioned in a desired positional relationship with respect to the imager 60, and the light captured by the lens 80 is input to the imager 60 to be in focus.

As illustrated in FIG. 6, a semi-cylindrical recess 57 extending along the Z-axis is formed in a portion of the outer wall of the lens barrel 50. The recess 57 is connected to the recess 26 of the case 20 and the recess 32 of the head 30, and receives a portion of the motor 141 described later, which is provided in the wiper device 140.

The imager 60, in other words the image sensor, is a sensing element and is configured by a CMOS, a CCD, or the like. The imager 60 is disposed inside the receptacle rather and rearward of the lens 80 and constitutes an imaging unit that receives light through the lens 80 and the optical components 100 and captures images of objects reflected in the lens 80. The imager 60 has a rectangular shape with the X-axis direction as a longitudinal direction and the Y-axis direction as a lateral direction, and is disposed so that the lens 80 and the imager 60 overlap as viewed from the Z-axis direction.

The imager substrate 70 is a substrate that includes various elements and other electronic components for driving the imager 60 and on which the ECU 71 illustrated in FIG. 1 is mounted. In addition to controlling the imager 60, the imager substrate 70 also performs on-off control of the infrared ray emitter 110. The imager substrate 70, as with the imager 60, is disposed inside the receptacle and rearward of the lens 80. The imager substrate 70 is a substantially rectangular plate-like substrate that includes two sides along the X-axis and two sides along the Y-axis, and the imager 60 is mounted on its surface, specifically, on the front end 2 side surface.

On the other side of the imager substrate 70, opposite the imager 60, a terminal 15 is connected to the imager substrate 70 for supplying power to the imager 60 and various elements on the imager substrate 70, and for outputting image data captured by the imager 60. The ECU 71 on the imager substrate 70 drives the motor 141 described later included in the wiper device 140, and is also capable of driving the motor 141 based on power supplied from the terminal 15. Specifically, a terminal support member 15a is connected to the other side of the imager substrate 70, and the terminal 15 is fitted inside the terminal support member 15a. The terminal 15 protrudes out of the cover 10 through the opening 13 of the cover 10.

The lens 80 is positioned outermost of the camera device 1, including the other optical components 100, with one side of the lens 80 exposed to the exterior. The optical axis of the lens 80 is in alignment with the optical axis of the lens barrel 50. For example, the lens 80 is a convex lens whose center is convex on the front end 2 side with respect to the periphery, and is disposed at the front end of the lens barrel 50. The lens 80 may be made of glass. The convex surface on the front side of the lens 80 is an exposed surface that is exposed through the opening 41 of the guide 40, and light from the exterior of the camera device 1 is captured through the opening 41.

The lens fixture 90 is a member that fixes the lens 80 to the front end of the lens barrel 50. The lens fixture 90 may be made of metal.

The lens fixture 90 is configured in the shape of a bottomed cylinder, with a circular opening 92 formed in the center of the bottom 91, which presses the periphery of the lens 80 against the lens barrel 50 side at the portion of the bottom 91 that is surrounding the opening 92. Specifically, the portion of the bottom 91 that is surrounding the opening 92 has a curved or conical trapezoidal inner wall surface that conforms to the shape of the lens 80 and presses the lens 80 against the lens barrel 50 side. Although the lens fixture 90 may be configured to directly contact the lens 80 and press the lens 80 against the lens barrel 50 side, a gasket 170 may be included between the lens fixture 90 and the lens 80 taking into account manufacturing tolerances of each component. That is, since the lens fixture 90 may fail to press the lens 80 against the lens barrel 50 side adequately due to manufacturing tolerances of the lens 80, the lens fixture 90, or the lens barrel 50, the gasket 170 may be interposed to absorb such manufacturing tolerances. The gasket 170 is a hollow thin conical plate made of a soft material, such as copper.

A female screw thread 94 is formed on the inner wall of the cylindrical portion 93 of the lens fixture 90, and a male screw thread 56 is formed on the outer circumference on the front end side of the lens barrel 50. In a state where the lens 80 and the gasket 170 are positioned at the front end of the lens barrel 50, the lens fixture 90 is rotated and fitted over the front end of the lens barrel 50. The female screw thread 94 and the male screw thread 56 are fastened, and the lens fixture 90 is fixed to the front end, on the lens 80 side, of the lens barrel 50. The lens 80 is fixed in such a manner that it is held between the lens fixture 90 and the front end of the lens barrel 50. Since the gasket 170 is disposed between the lens fixture 90 and the lens 80, the gasket 170 functions as a thread position adjuster, and the lens 80 is properly fixed at a desired position between the lens barrel 50 and the lens fixture 90. That is, although it is necessary to align the thread start positions of the male screw thread 56 and the female screw thread 94 and to align positions of the rotational direction of the male screw thread 56 and the female screw thread 94 after fastening, the sensitivity of the screw axial force to angle can be reduced when the gasket 170, which is made of a soft material such as copper, is disposed. Thus, the degree of freedom of the fastening angle of the lens fixture 90 in the rotational direction of the male screw thread 56 and the female screw thread 94 is increased, fascinating adjustment of thread positions of the male screw thread 56 and the female screw thread 94, thereby allowing the lens 80 to be fixed properly in a desired position.

A circular groove 95 is formed on the guide 40 side of the bottom 91 of the lens fixture 90, that is, on the side facing the guide 40. An O-ring 96 is fitted within this groove 95. This seals the opening 41 of the guide 40 and the outer circumference side of the lens fixture 90, that is, the side where the infrared ray emitters 110 are disposed, and provides waterproofing for the infrared ray emitter 110.

A through hole 97 is formed in the bottom 91 of the lens fixture 90 for communication between the lens 80 side and the lens barrel 50 side. The drive shaft 143 of the wiper device 140 described later is inserted through the through hole 97.

The optical components 100 are disposed on the imager 60 side of the lens 80 in the hollow 51 of the lens barrel 50. Although the details are not shown, the optical components 100 are configured by arranging a plurality of lenses in the Z-axis direction. The lens 80 and the optical components 100 collect the captured light and input it to the imager 60. The arrangement, number, and shape of the optical components 100 are arbitrary, but they are set so that the captured light can be focused and input to the imager 60.

Each infrared ray emitter 110 outputs infrared rays toward the exterior of the receptacle. For example, the infrared ray emitter 110 is configured by a semiconductor light source such as an infrared Light Emitting Diode (LED), a Vertical Cavity Surface Emitting Laser (VCSEL), or a Photonic Crystal Laser (PCSL). In this embodiment, the infrared ray emitter 110 is configured by an infrared LED. The infrared LED is substantially hemispherical, with a spherical surface on the side that emits infrared rays and a flat surface on the opposite side, and wires or pads (not shown) are formed on the flat surface side. The flat side of the infrared LED is directly mounted on one side of the LED substrate 120.

Each infrared ray emitter 110 is disposed adjacent to the lens 80 and emits infrared rays toward the exterior of the camera device 1. When the environment around the camera device 1 is dark, infrared rays are emitted toward the exterior of the camera device 1, and the lens 80 functions as a receiving section to receive the reflected infrared rays, thereby enabling night vision.

The infrared ray emitter 110 is provided at each of the four corners of the camera device 1, which has a rectangular shape as viewed from the Z-axis direction. The optical axis of each infrared ray emitter 110 is arbitrary as long as infrared rays can be emitted over a capture range of the camera device 1. Preferably, in the present embodiment, the optical axis of each infrared ray emitter 110 may be tilted with respect to the optical axis of the lens barrel 50, which can suppress incidence of infrared ray reflection light into the lens 80 at an excessively high intensity.

A current carrying wire 110a for supplying power to a respective one of the infrared ray emitters 110 is electrically connected to the imager substrate 70 through a through hole 111 which is a wiring pathway formed in the lens barrel 50 or the like. Although not shown, the current carrying wire 110a is covered with a resin or the like, and is insulated from the lens barrel 50. Through this current carrying wire 110a, the ECU 71 on the imager substrate 70 controls the power supply to the infrared ray emitter 110.

The LED substrate 120 is a mounting substrate that serves as a base for holding the infrared ray emitters 110. In the present embodiment, the infrared ray emitters 110 are directly mounted on the LED substrate 120. As illustrated in FIG. 6, the LED substrate 120 has a rectangular frame shape, and has a circular opening 121 in the center. The diameter of the opening 121 matches the outer diameter of the lens fixture 90. As illustrated in FIG. 4, the lens fixture 90 is inserted into the opening 121.

The rubber seal 130 is a member that is sandwiched between the guide 40 and the head 30 to prevent intrusion of water through a gap between the guide 40 and the head 30. The rubber seal 130 has a rectangular frame shape with a hollow 131, and each of the four corners of the hollow 131 is rounded as a portion of a circular hole 131a that conforms to the shape of the infrared ray emitter 110. The rubber seal 130 has outer dimensions that are greater than the inner dimensions of the head 30, and the dimensions of the hollow 131 are less than the outer dimensions of the guide 40. This allows the gap between the guide 40 and the head 30 to be covered and sealed.

The wiper device 140 is configured as including a motor 141, a gearbox 142, a drive shaft 143, a linkage 144, a lens wiper 145, and a light source wiper 146.

The motor 141 is a source of power for the wiper device 140, and its drive is controlled by the ECU 71 of the imager substrate 70. The ECU 71 of the imager substrate 70 is capable of adjusting an amount of power supplied to the motor 141, and the motor 141 increases or decreases its rotational speed according to the increase or decrease in the amount of power supplied thereto. The motor 141 has a cylindrical shape, and the built-in motor rotation axis (not shown) is oriented in the Z-axis direction, and the longitudinal direction of the motor 141 is in the Z-axis direction. The motor 141, the gearbox 142 and the drive shaft 143 are arranged to be aligned along the Z-axis direction, that is, along the optical axis of the lens 80, and the dimensions of the motor drive system and of the camera device 1 are downsized.

The motor 141, together with the gearbox 142, is received in the accommodation space 180 configured by the recess 26 of the case 20, the recess 32 of the head 30, and the recess 57 of the lens barrel 50 described above. Connecting this accommodation space 180 with the through hole 111 allows the camera device 1 to be downsized as compared to a case where these are formed separately.

Although an arbitrary type of motor may be applied as the motor 141, a DC motor is applied here. As the motor 141, a type of motor capable of detecting a rotation angle to perform drive control, for example, a servo motor or a stepping motor, may be used. However, the servo motor is expensive and the stepping motor is unable to be actuated at high speeds. On the other hand, monitoring the wiper position by image analysis, as described later, may not require detection of the rotation angle of the motor 141. Therefore, a DC motor, which is inexpensive and capable of high-speed actuation, is applied as the motor 141.

The gearbox 142 contains a gear mechanism connected to the rotation shaft of the motor 141, and attenuates the motor rotational speed to acquire a desired torque, which is in turn output from the drive shaft 143.

The drive shaft 143 is connected to the linkage 144, and transmits the desired torque converted by the gearbox 142 to the linkage 144 as a drive force. In the present embodiment, since the motor 141 and the gearbox 142 are contained in the accommodation space 180, the drive shaft 143 needs to protrude from the accommodation space 180 to the linkage 144. Therefore, the drive shaft 143 is inserted through the through hole 97 formed in the bottom 91 of the lens fixture 90. The drive shaft 143 is configured to connect two members coaxially, for example. In FIG. 6, the portion of the drive shaft 143 connected to the gearbox 142 and the portion connected to the linkage 144 are depicted separately so that the connection relationship with the linkage 144 can be seen.

The linkage 144 is connected to the lens wipers 145 and the light source wipers 146 and drives the lens wipers 145 and the light source wipers 146 based on the drive force transmitted from the drive shaft 143. The linkage 144 is disposed in a space 44 between the first guide member 42 and the second guide member 43 and is connected to all of the lens wipers 145 and the light source wipers 146. Although the linkage 144 may have an arbitrary structure, it may include, in the present embodiment, a U-shaped portion 144a and branched portions 144b connected from the U-shaped portion 144a to some of the light source wipers 146, as illustrated in FIG. 6. The drive shaft 143 is connected to the U-shaped portion 144a at the position corresponding to the through hole 97, and the drive force is transmitted to the linkage 144. When the motor 141 is driven and the drive force is transmitted to the linkage 144, the lens wipers 145 and the light source wipers 146 are driven simultaneously. When the drive force is increased or decreased by an increase or decrease in motor rotation, the wiper speed can be increased or decreased accordingly.

Each lens wiper 145 is a wiper that wipes off deposits on the convex surface that is the exposed surface of the lens 80. Specifically, the lens wiper 145 includes a shaft 145a, an arm 145b, and a wiping member 145c, as illustrated in FIG. 2. The lens wiper 145 includes the arm 145b exposed on the surface of the guide 40 and the wiping member 145c exposed on the surface of the lens 80. The shaft 145a is connected to the linkage 144 through the through hole 42b formed in the first guide member 42. As illustrated in FIG. 6, a recess 91a is formed on one side of the bottom 91 of the lens fixture 90 on the guide 40 side at a position corresponding to the shaft 145a, and the shaft 145a is received in this recess 91a. Furthermore, a tip end of the shaft 145a protrudes outwardly from the guide 40 through a through hole 43a formed in the second guide member 43, and the arm 145b is attached to this protruding portion.

The wiping member 145c has a structure in which a wiper rubber is attached to a wiper blade. The wiper blade is connected to the arm 145b, and the wiper rubber is in contact with the surface of the lens 80. When the linkage 144 is driven based on motor rotations, the arm 145b and the wiping member 145c are swung around the shaft 145a to remove foreign matter from the surface of the lens 80 by the wiper rubber. A water-repellent coating is applied to the wiper rubber so that the wiping effect on the lens 80 can continue for a longer period of time, thereby providing higher visibility, that is, clearer image data, for a longer period of time.

In the present embodiment, one lens wiper 145 is disposed on each side of the center of the lens 80, at a distance from the center of the lens 80. More specifically, the pair of lens wipers 145 are disposed lineally symmetrically with respect to a line along the Y-axis passing through the center of the lens 80 as the line of symmetry. The direction in which the pair of lens wipers 145 are aligned is the X-axis direction, which coincides with the longitudinal direction of the imager 60 that is rectangular in shape as illustrated in FIG. 6. In the present embodiment, this direction coincides with the horizontal direction when mounted to the vehicle.

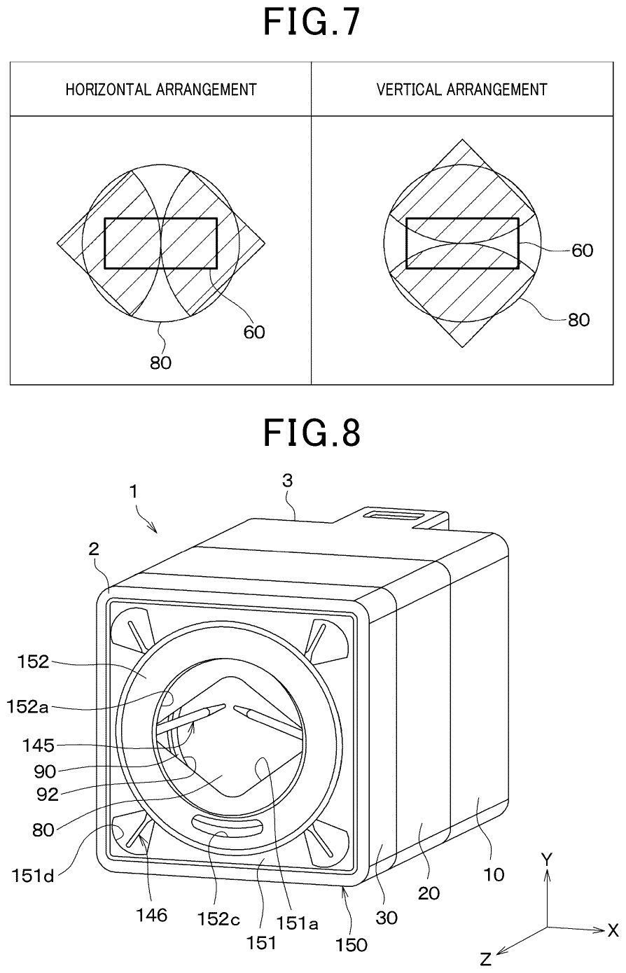

The longitudinal direction of the imager 60 is the direction in which the capture range is wider. On the other hand, the direction in which the two lens wipers 145 are aligned is a direction in which foreign matter can be removed over a wider range. Making these directions coincide allows the lens wipers 145 to wipe a wider area within the capture range of the imager 60. In FIG. 7, ranges of movement of the lens wipers 145, that is, ranges in which the lens wipers 145 can wipe off the foreign matter, are indicated by hatch marks, in the case of a horizontal arrangement where the longitudinal direction of the imager 60 coincides with the direction in which the two lens wipers 145 are aligned, and in the case of a vertical arrangement where the longitudinal direction of the imager 60 is perpendicular to the direction in which the two lens wipers 145 are aligned. As illustrated in FIG. 2, in the case of the horizontal arrangement, a smaller area fails to be wiped within the capture range of the imager 60, indicated by the bold line in FIG. 7. On the other hand, in the case of the vertical arrangement, a larger area fails to be wiped within the capture range of the imager 60 than in the case of the horizontal arrangement. Therefore, making the longitudinal direction of the imager 60 coincide with the direction in which the two lens wipers 145 are aligned enables wiping of the surface of the lens 80 over a wider area, thereby increasing the capture range in which clear images can be captured.

Depending on how the camera device 1 is mounted to the vehicle, it is preferable that the direction in which the lens wipers 145 are aligned coincides with the horizontal direction. In other words, when the camera device 1 is mounted in a normal position, that is, when the camera device 1 is mounted to an object such as a vehicle or the like in a normal position, it is preferable that the direction in which the lens wipers 145 are aligned coincides with the substantially horizontal direction. The horizontal direction is a direction in which the imager 60 is intended to capture images over a wider area. That is, there are various objects in the horizontal direction, and image data related to them is desired to be acquired in this direction. However, since there are not many objects in the vertical direction, especially in the upper direction, and there is not much image data required, the longitudinal direction of the imager 60 is preferably set to the horizontal direction. Therefore, in the present embodiment, the longitudinal direction of the imager 60 coincides with the horizontal direction, and the lens wipers 145 are also arranged in the horizontal direction. This allows the lens 80 to be wiped over a wider range in the direction where more image data is required, thereby ensuring that clear image data can be acquired.

Even when each lens wiper 145 is in the standby mode in which it is not actuated, the arm 145b and wiping member 145c are positioned on the exposed surface of the lens 80, partially obstructing light from entering the lens 80. The range of movement of the lens wiper 145 is within the convex surface of the lens 80, and the arm 145b and wiping member 145c are swung between the uppermost and lowermost positions in FIG. 3, with the uppermost position being the standby position in the standby mode.

Each light source wiper 146 is a wiper that wipes off deposits on the surface of the guide 40 at the position corresponding to the infrared ray emitter 110. In the present embodiment, one light source wiper 146 is disposed at a position corresponding to each of the infrared ray emitters 110. More specifically, the light source wiper 146 is disposed at a respective one of the four corners of the camera device 1 as viewed from the Z-axis direction.

Like the lens wipers 145, each light source wiper 146 also includes a shaft 146a, an arm 146b, and a wiping member 146c, as illustrated in FIG. 2 and elsewhere. The light source wiper 146 has the shaft 146a connected to the linkage 144 through the through hole 42b formed in the first guide member 42. As illustrated in FIGS. 4 and 6, for each light source wiper 146, a recess 91b is formed on one side of the bottom 91 of the lens fixture 90 on the guide 40 side at a position corresponding to the shaft 146a, and the shaft 146a is received in this recess 91b. Furthermore, a tip end of the shaft 146a protrudes outwardly from the guide 40 through a through hole 43a formed in the second guide member 43, and the arm 145b and the wiping member 146c are attached to this protruding portion. When the light source wiper 146 is swung based on the motor rotation, it operates to remove foreign matter from the surface of the guide 40 at the position corresponding to the infrared ray emitter 110. The camera device 1 of the present embodiment is configured in the manner described above.

### Actuation of Camera Device

The actuation of the camera device 1 and the camera system configured as above will now be described. In a case where the camera device 1 is used on-board, it is applied to capture images of surroundings of a vehicle. For example, the camera device 1 is actuated during travel of the vehicle or during parking assistance, and images are captured by the imager 60 during such time periods.

Specifically, based on instructions from the external ECU 200, the ECU 71 provided on the imager substrate 70 controls capturing of images by the imager 60, and image data captured by the camera device 1 via the control terminal 15 is output to the external ECU 200. In the external ECU 200, the image data is analyzed.

At this time, in a situation where surroundings of the camera device 1 are bright, for example, during daytime, the image data is sufficient in brightness. In such a situation, the imager 60 capture images without causing the infrared ray emitter 110 to emit infrared rays.

In a situation where the surroundings of the camera device 1 are dark, for example at night, the image data is not sufficient in brightness. Thus, the image data captured by the camera device 1 is analyzed by the external ECU 200, and when it is not sufficiently bright, the external ECU 200 instructs the ECU 71 of the imager substrate 70 to cause the infrared ray emitters 110 to emit light. The imager 60 captures images by receiving the reflected infrared light from objects around the camera device 1. This allows clear image data to be acquired even at night.

Furthermore, deposits such as raindrops on the lens 80 are detected by the external ECU 200 analyzing the image data captured by the camera device 1. Upon detection of deposits, the external ECU 200 instructs the ECU 71 of the imager substrate 70 to actuate the lens wipers 145 to wipe the surface of the lens 80. This allows deposits on the surface of the lens 80 to be removed, enabling acquisition of clear image data over the long term. At the same time, the light source wipers 146 are also actuated, and the surface of the guide 40 is wiped by the light source wipers 146 at the positions corresponding to the positions of the infrared ray emitters 110. Thus, even when there are deposits attached to these positions, they may be removed at the same time, allowing for good infrared ray emission by the infrared ray emitters 110 and good nighttime imaging.

In the standby position of each lens wiper 145, the arm 145b and the wiping member 145c are positioned on the surface of the lens 80, partially inhibiting light from entering the lens 80. In this manner, even in the standby position, the lens wiper 145 is positioned to partially reduce the light entering the lens 80, thereby reducing the amount of ambient light near where the lens wiper 145 is disposed. Therefore, even without a separate device for detecting the current position of the lens wiper 145, the current position can be determined from the image data, and the position of the lens wiper 145 can be accurately controlled based on the determined current position.

### Actions and Effects of Camera Device 1

In the camera device 1 of the present disclosure described above, the wiper member 145c of each lens wiper 145 is disposed in front of the lens 80, which allows the exposed surface of the lens 80 to be wiped. Therefore, with the lens wipers 145, deposits on the surface of the lens 80, e.g., raindrops, can be evened out and dirt can be removed. Even in the standby mode of the lens wipers 145, the arms 145b and the wiping members 145c are positioned to inhibit light from entering the lens 80, and are positioned on the exposed surface of the lens 80. Therefore, the wiping members 145c do not straddle the boundary between the lens 80 and the lens fixture 90 when wiping the surface of the lens 80, thus allowing the surface of the lens 80 to be wiped adequately. Since a cover glass is not provided in front of the lens 80 and lens fixture 90 for their surfaces to be flushed with each other, an increase in size and an increase in cost can be suppressed. Therefore, the camera device 1 is capable of adequately wiping off deposits on the surface of the lens 80 while suppressing the increase in the size of the device.

The camera device 1 of this disclosure also provides the following advantages.

(1) Even when the lens wipers 145 are in the standby mode in which they are not being actuated, the arms 145b and the wiping members 145c are positioned on the surface of the lens 80, partially blocking the light from entering the lens 80. This can reduce the peripheral illumination around where the lens wipers 145 are disposed. This allows the current positions of the lens wipers 145 to be determined from the image data without providing a separate device for detecting the current positions of the lens wipers 145, and allows position control of the lens wipers 145 to be performed with high accuracy based on the determined current positions.

(2) One pair of lens wipers 145 are disposed facing and away from each other along the longitudinal direction of the imager 60. In this manner, the direction in which the lens wipers 145 are aligned coincides with the longitudinal direction of the imager 60, allowing the lens wipers 145 to wipe a broader area within the capture range of the imager 60.

(3) The lens wipers 145 are motor-driven, and the motor 141, the gearbox 142 and the drive shaft 143 are arranged in the Z-axis direction, that is, in the direction in which the lens 80 and the optical components 100 are aligned. This allows the motor drive system and the camera device 1 to be downsized.

(4) The accommodation space 180 where the motor 141 and the gearbox 142 are received is connected to the through hole 111. This can downsize the camera device 1 as compared to the case in which these are formed separately. The through hole 111 is used here as a pathway for the current carrying wire 110a of the infrared ray emitter 110 to pass through. In some embodiments where accessories that need to be energized are disposed on the front end 2 side of the lens barrel 50, a through hole may be formed for a wiring for energizing the accessories to pass through. Connecting the accommodation space 180 to this through hole allows the camera device 1 to be downsized. Of course, the same applies when the wires for energizing different types of accessories are passed through the same through hole.

(5) In addition to the lens wipers 145, the light source wipers 146 are provided so that deposits on the surface of the guide 40 at positions corresponding to the infrared ray emitters 110 can also be wiped off. This can inhibit the acquired image data from becoming insufficient in light intensity due to diffuse reflection of light from the deposits.

### Second Embodiment

A second embodiment of the present disclosure will now be described. The second embodiment differ from the first embodiment in that a wiper cover is further provided to protect the lens wipers 145 and light source wipers 146. Only differences of the second embodiment from the first embodiment will be described. The same constituents are assigned the same reference numbers.

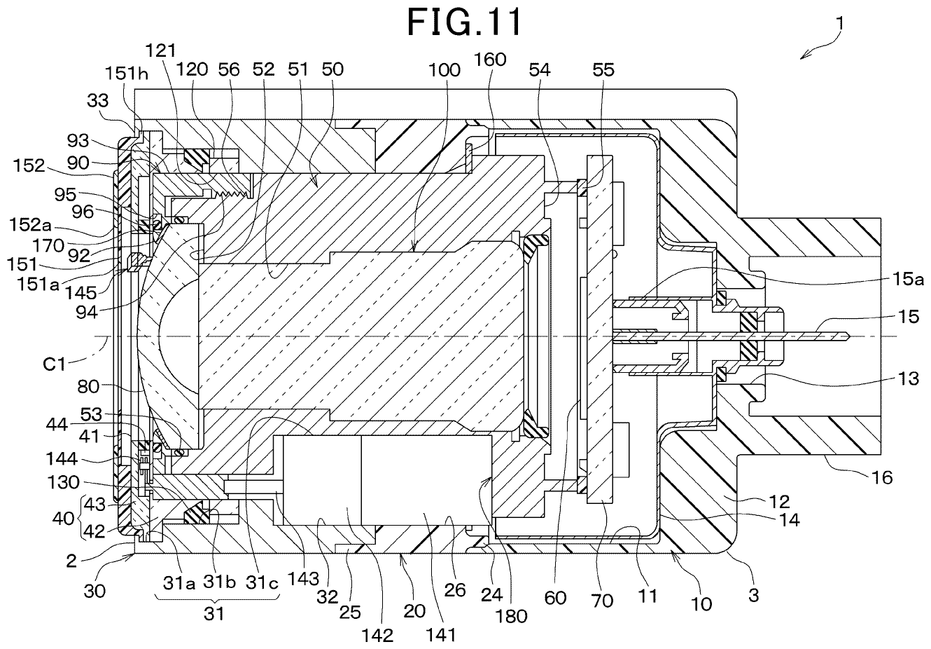

As illustrated in FIGS. 8 to 13, in the present embodiment, a wiper cover 150 is provided on the front end 2 side further than the lens wipers 145 and the light source wipers 146. In other words, the wiper cover 150 is provided on the opposite side of the lens wipers 145 from the lens 80 and on the opposite side of the light source wipers 146 from the guide 40. The wiper cover 150 protects the lens wipers 145 and the light source wipers 146. The wiper cover 150 includes a frame 151 and a cap 152.

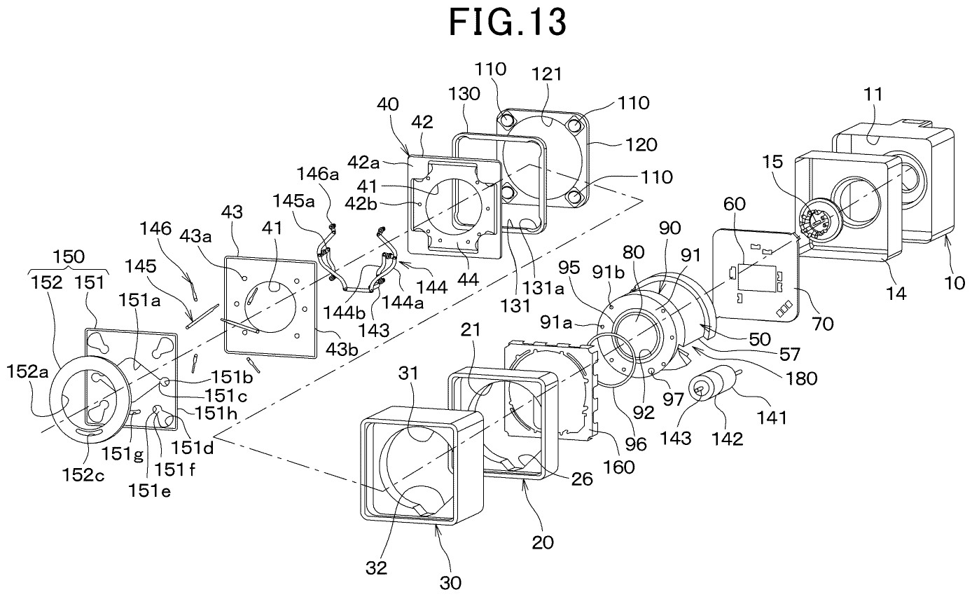

The frame 151 of the present embodiment is formed of a plate-like member with a rectangular outline shape as viewed from the Z-axis direction. As illustrated in FIG. 13, the frame 151 has a first opening 151a formed in a position corresponding to the range of movement of each lens wiper 145, and also has shaft holes 151b formed on both sides of the first opening 151a in the X-axis direction. Furthermore, the first opening 151a and the shaft holes 151b are connected by a notch 151c. The first opening 151a has a diamond shape, with the longer of the two intersecting diagonals forming the X-axis direction and the shorter forming the Y-axis direction. The combined range of movement of the two fan-shaped lens wipers 145 forms a diamond shape. The dimensions of the first opening 151a are set to be wider than the capture range of the imager 60, so that the capture range is not covered by the frame 151. The shaft hole 151b is formed in a position corresponding to the shaft 145a of the lens wiper 145, and is a circular hole through which the shaft 145a is inserted. The notch 151c is formed to widen the gap where the first opening 151a and the shaft hole 151b are connected.

The frame 151 has four second openings 151d corresponding to the four light source wipers 146. For each of the four second openings 151d, a shaft hole 151e is formed closer to the center of the lens 80, and a notch 151f is formed between the second opening 151d and the shaft hole 151e, connecting them. Each second opening 151d is a fan-shaped opening to match the range of movement of the light source wiper 146. Each fan-shaped opening is oriented so that the center of the fan-shaped opening is closest to the center of lens 80 and the arc portion of the fan-shaped opening is closest to a corresponding one of the four corners of the frame 151. The shaft hole 151e is formed in a position corresponding to the shaft 146a of the light source wiper 146, and is a circular hole through which the shaft 146a is inserted. The notch 151f is formed to widen the gap between the second opening 151d and the shaft hole 151e.

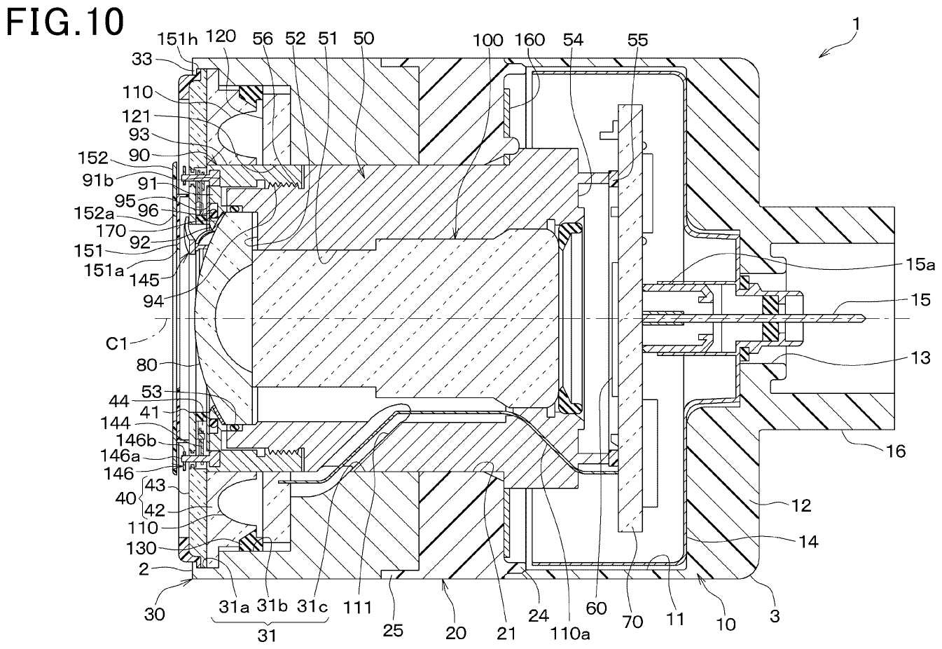

As illustrated in FIGS. 10 and 13, of the present embodiment, the outer edge portion of the second guide member 43 is recessed from the inside portion thereof, which is referred to as a recessed portion 43b. On the other hand, the outer edge portion of the frame 151 on the second guide member 43 side has a protruding portion corresponding to the recessed portion 43b, and the protruding portion has a flange portion 151h protruding in the XY plane directions formed at its tip position. This flange portion 151h extends more to the rear end 3 side than the protruding portion 33 formed on the front end 2 side of the head 30, and is attached to the head 30.

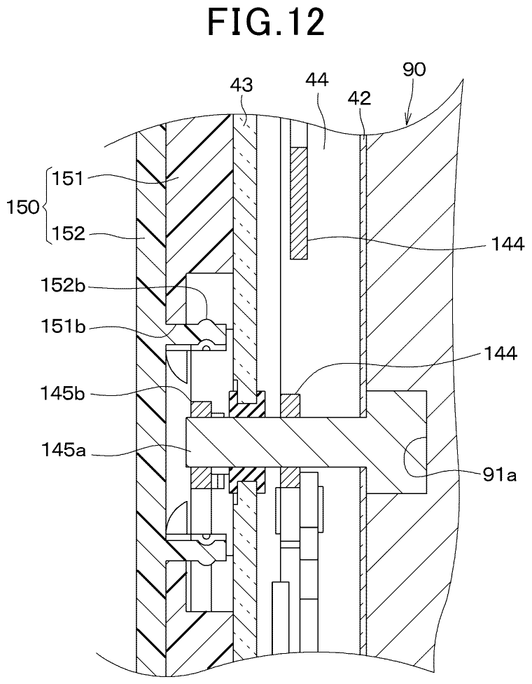

The cap 152 is disposed on the front end 2 side of the frame 151, and is annular in shape. The window hole 152a in the cap 152 is circular in shape with a size corresponding to the lens 80, and the first opening 151a is exposed through the window hole 152a. The width of the cap 152 and the window hole 152a are dimensioned so that the cap 152 can cover the shafts 145a of the lens wipers 145 and the shafts 146a of the light source wipers 146. As illustrated in FIG. 12, one side of the cap 152, which is on the frame 151 side, has engagement protrusions 152b that protrude toward the rear end 3, and the cap 152 is integrated with the frame 151 by the engagement protrusions 152b fitting within the shaft holes 151b.

Although not shown, the engagement protrusions 152b are not formed in positions corresponding to the notches 151c, and have a shape that does not affect the operations of the lens wipers 145.

As illustrated in FIG. 13, a drainage hole 151g is formed in the frame 151, in a position adjacent to the first opening 151a of the frame 151, and a drainage hole 152c is formed in the cap 152, in a position away from the window hole 152a of the cap 152. These drainage holes 151g and 152c are formed in positions earthward of the lens 80 when the camera device 1 is mounted to a vehicle. The drainage holes 151g and 152c are formed in positions corresponding to each other. When the cap 152 is attached to the frame 151, they are connected, leading to a structure such that the gap between the lens 80 and the frame 151 is in communication with the outward side of the cap 152.

In the camera device 1 configured in this manner, the lens wipers 145 are disposed inside the frame 151. When actuated, the wiping members 145c are exposed through the first opening 151a, and the shafts 145a, etc. are partially covered by the frame 151 and hidden. In the Z-axis direction, the surface of the cap 152 is positioned on the foremost end 2 side, and the lens wipers 145 are positioned on the rear end 3 side of the cap 152. This can make it difficult for the wiping members 145c to be subjected to force when the vehicle is pushed outward or something external comes into contact with the vehicle, thus preventing damage to the wiping members 145c.

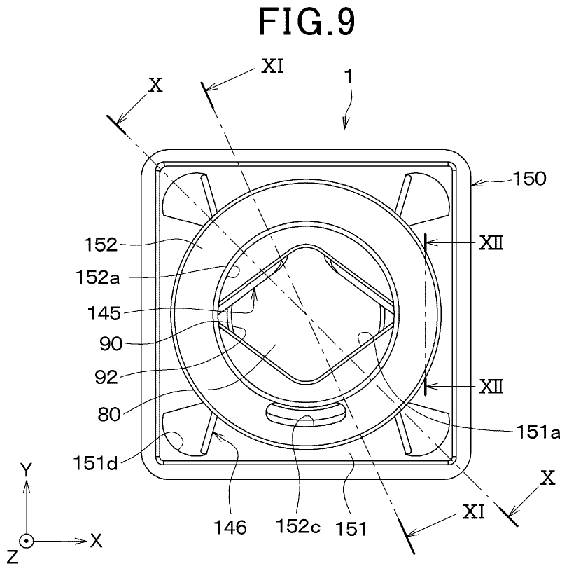

In addition, in the standby mode, the lens wipers 145 may be stopped in positions along the edge of the first opening 151a, as illustrated in FIG. 9. This allows at least a portion of the wiping member 145c of each lens wiper 145 to be stowed between the frame 151 and the lens 80. This can reduce the risk of the lens wipers 145 being tampered with or coming into contact with something external to the camera device 1, and prevent damage to the lens wipers 145. The light source wipers 146 may also be stowed between the frame 151 and the guide 40 in the standby mode by stopping them in positions along the edges of the second openings 151d, providing the similar advantages as described above.

Furthermore, because the notch 151c is provided between the first opening 151a and each shaft hole 151b, the arms 145b and wiper members 145c of the lens wipers 145 can be readily replaced through the notches 151c. Similarly, the notch 151f is provided between each second aperture 151d and the shaft hole 151e, which allows the arm 146b and the wiping member 146c of each light source wiper 146 to be easily replaced through the notch 151f.

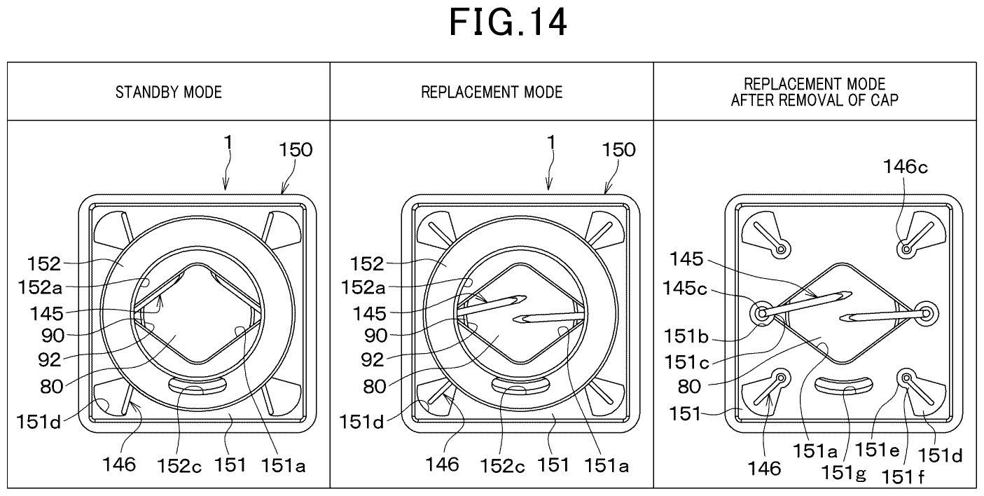

For example, in cases where clear image data cannot be acquired despite the wipers operating, the external ECU 200 determines that it would be better to replace the lens wipers 145 or light source wipers 146 based on image analysis, and places the camera device 1 in a replacement mode. As illustrated in FIG. 14, the standby position is changed from the standby position in the standby mode to the standby position in the replacement mode, and the arms 145b and wiping members 145c are positioned closer to the center of the convex surface of the lens 80. Preferably, in order to prevent interference between the lens wipers 145, the lengths of the arm 145b and wiping member 145c may be set so that the tip of the wiping member 145c barely reaches or does not reach the center of the lens 80. Alternatively, the lengths of the arm 145b and wiping member 145c may be set greater than such lengths in order to be able to wipe a wider area. In this case, it is preferable to offset positions of the tips of the wiping members 145c in the Y-axis direction, as illustrated in FIG. 14. When the cap 152 is removed in this state, the arms 145b and wiping members 145c are positioned within the notch 151c. This allows the arms 145b and wiping members 145c to be readily removed and replaced with new ones through the notch 151c.

The same applies to the light source wipers 146, each of which is in the standby position when they are placed in the replacement mode, with the arm 146b and wiping member 146c positioned within the notch 151f. This allows the arm 146b and the wiping member 146c of each light source wiper 146 to be removed and replaced with new ones readily through the notch 151f.

On the other hand, when the wipers are not in the replacement mode, for example when they are being actuated normally, the arm 145b and wiping member 145c of each lens wiper 145 are in positions different from the position of the notch 151c, and the arm 146b and wiping member 146c of each light source wiper 146 are in positions different from the notch 151f. This prevents the accidental detachment of these parts due to external forces, and also prevents tampering.

Furthermore, although the wiper cover 150 is provided, the water drainage hole 151g is formed in the frame 151 and the water drainage hole 152c is formed in the cap 152, allowing water to drain even in the event that water intrudes into the inside of the wiper cover 150.

### Third Embodiment

A third embodiment of the present disclosure will now be described. The third embodiment differ from the second embodiment in that the guide 40, the infrared ray emitters 110, the light source wipers 146 are omitted. Only differences of the third embodiment from the second embodiment will be described. The same constituents are assigned the same reference numbers.

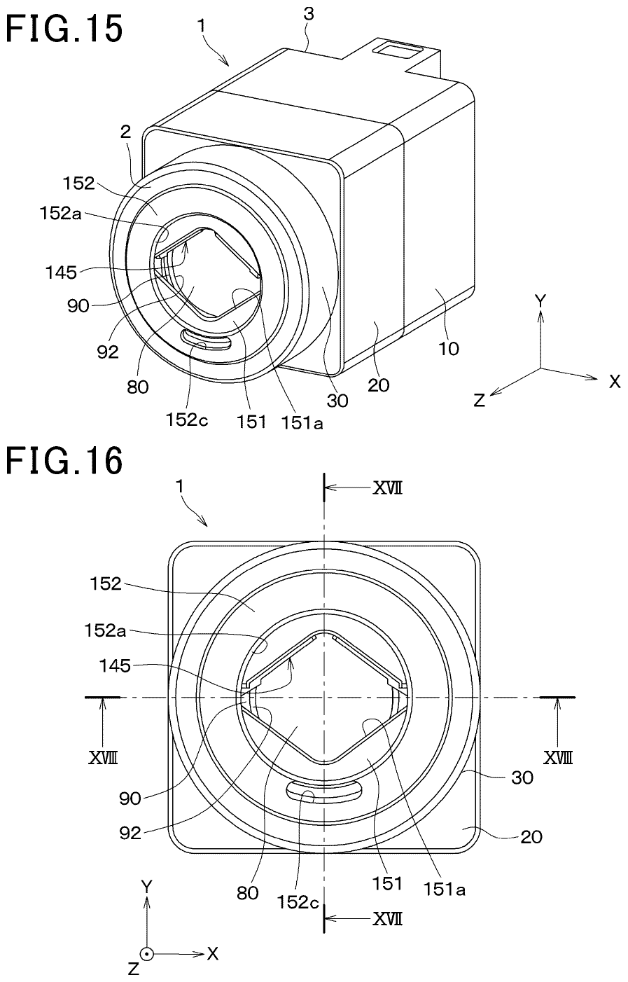

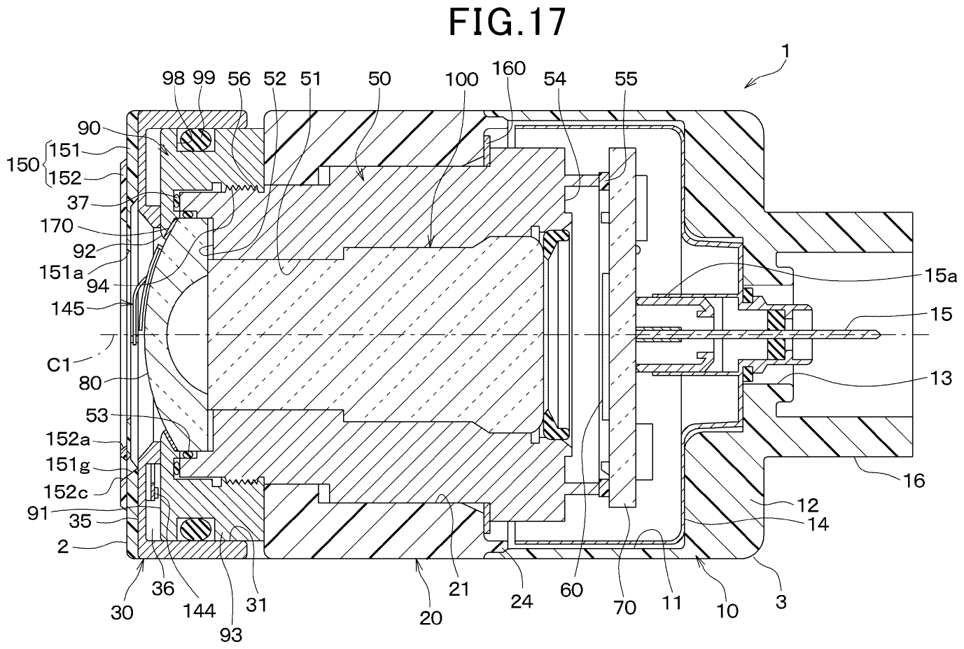

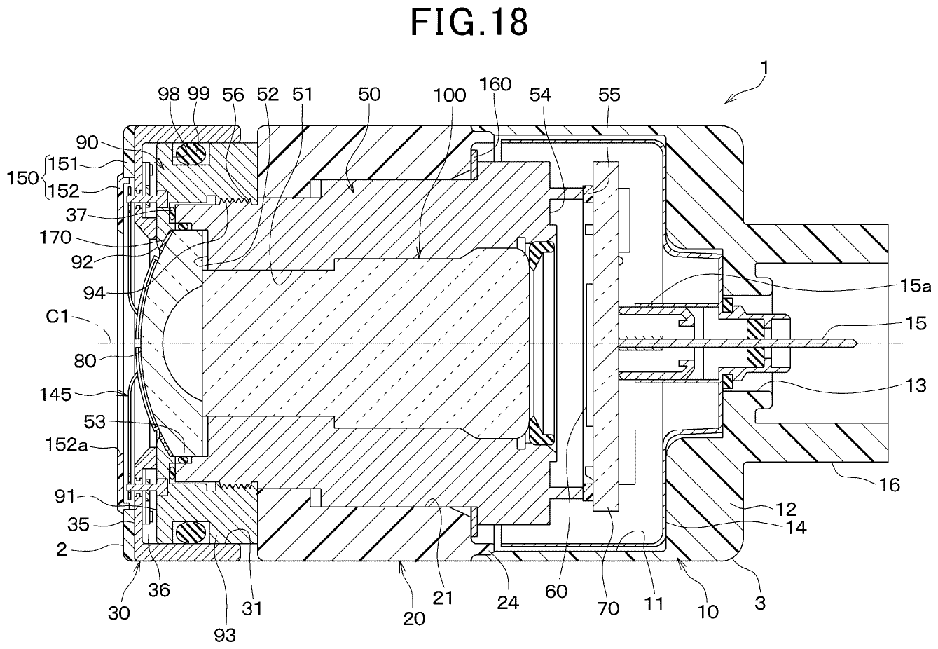

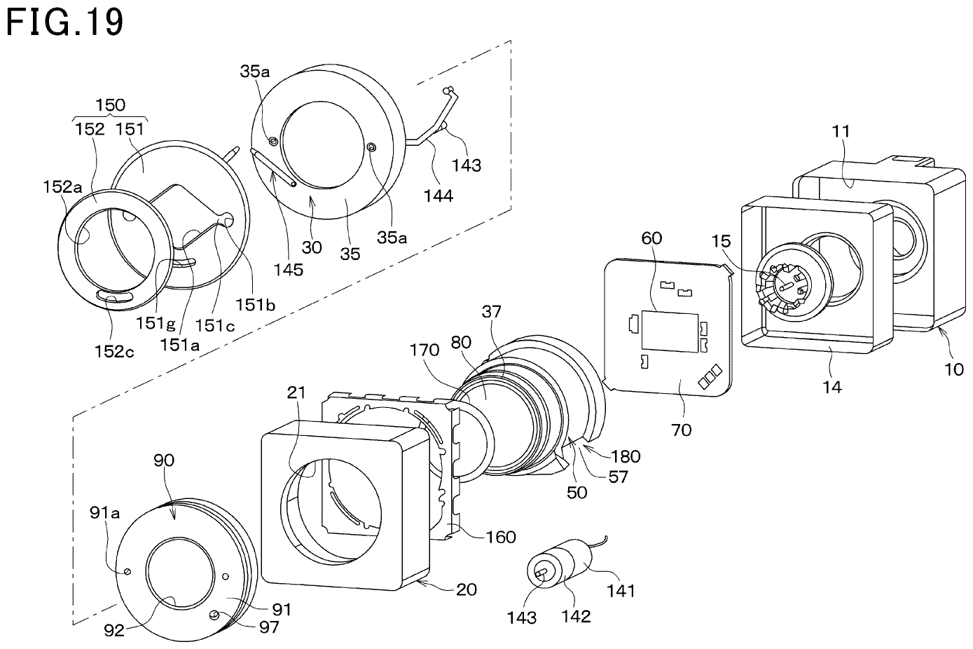

As illustrated in FIGS. 15 to 19, the camera device 1 of the present embodiment does not include the infrared ray emitters 110 and the light source wipers 146, so the head 30 is configured as a cylindrical shape and is attached to the lens fixture 90 by the head 30 slipping over the lens fixture 90. The head 30 has a surface 35 on the front end 2 side, and the linkage 144 is disposed in the gap 36 between the surface 35 and the lens fixture 90, and the shafts 145a is inserted through the respective through holes 35a formed in the surface 35. The inner wall surface of the head 30 and the outer circumference of the lens fixture 90 are disposed in contact with each other or with a small gap, and a ring-shaped groove 98 is formed in a portion of the outer circumference of the lens fixture 90 that overlaps with the inner wall surface of the head 30, and an O-ring 99 is fitted within the groove 98. This O-ring 99 is in contact with the inner wall surface of the head 30, providing a seal between the head 30 and the lens fixture 90.

In addition, the wiper cover 150 is directly attached to the head 30, and the guide 40 is not used. Specifically, the frame 151 is directly attached to the annular surface on the front end 2 side of the head 30, and the cap 152 is attached to the frame 151. The frame 151 is circular and has a first opening 151a, a shaft hole 151b, a notch 151c, and a drainage hole 151g all formed inside. The structure of the cap 152 is the same as in the second embodiment. The method of attaching the frame 151 to the head 30 is arbitrary. For example, the frame 151 may be attached to the head 30 with an adhesive. Alternatively, the frame 151 may have a circular protrusion formed on the outer edge of the frame 151, and the frame 151 is snapped over the head 30.

Since the structure is such that the guide 40 is not used and the wiper cover 150 is attached directly to the head 30, an O-ring 37 is provided between the inner wall surface of the head 30 and the front end of the lens barrel 50, thereby providing a seal between them.

In the configuration described above, the guide 40, the infrared ray emitters 110, and the light source wipers 146 are not provided, and the wiper cover 150 may be attached to the head 30. Such a configuration can also provide the same advantages as the second embodiment. Other Embodiments

Although the present disclosure has been described in accordance with the above-described embodiments, it is not limited to such embodiments, but also encompasses various variations and variations within equal scope. In addition, various combinations and forms, as well as other combinations and forms, including only one element, more or less, thereof, are also within the scope and idea of the present disclosure.

(1) For example, in each of the above embodiments, the camera device 1 has been described as an example of an imaging apparatus. Instead, the present disclosure may also be applied to imaging apparatuses such as stereo cameras in LiDAR.

(2) In each of the above embodiments, the camera device 1 corresponding to the imaging apparatus is an onboard camera for a vehicle, but the present disclosure is not limited to such an onboard camera. However, since there is a demand for downsizing, application of the wiper device 140 of the present disclosure can contribute to further downsizing.

(3) In each of the first and second embodiments above, the head 30 has a rectangular cylindrical shape and is equipped with the light source wipers 146, while in the third embodiment, the head 30 has a cylindrical shape and is not equipped with the light source wipers 146. However, the shape of the head 30 and the presence or absence of the light source wipers 146 do not necessarily have to be in this relationship. For example, the head 30 may be configured as having a rectangular cylindrical shape without the light source wipers 146. Alternatively, for example, the head 30 may be configured as having a rectangular cylindrical shape as in the second embodiment but without the guide 40, or the head 30 may be configured as having a cylindrical shape as in the third embodiment but with the guide 40.

(4) In each of the above embodiments, the lens wipers 145 are each configured as including the arm 145b and the wiping member 145c formed of a blade and wiper rubber. In an alternative, the arm and blade may be integrated. The same is true for the light source wipers 146.

(5) In each of the above embodiments, the infrared ray emitters 110 that emit infrared rays has been described as an example. In an alternative, light sources that emit light other than infrared rays, such as visible light may be used.

(6) In each of the above embodiments, image analysis is performed by the external ECU 200, which is located outside the camera device 1, and the wiper device 140 is driven based on results of this image analysis. In an alternative, this image analysis may be performed by the ECU 71 of the camera device 1. In addition, in each of the above embodiments, the camera device 1 is configured as including the ECU 71. In an alternative, the camera device 1 may be configured as not including the ECU 71. In this case, the various elements on the imager substrate 70 are controlled based on control signals from the external ECU 200, and driving of the imager 60 and the wiper device 140 is thereby controlled.

Note that the present disclosure is not limited to the above-described embodiments, and it can be modified as appropriate. In addition, the above embodiments are not irrelevant to each other, and they can be appropriately combined unless the combination is clearly impossible. It is unnecessary to say that the elements constituting the embodiments are not necessarily essential unless explicitly stated as essential or obviously considered essential in principle. In addition, when a numerical value such as the number, value, amount, or range of a component(s) of any of the above-described embodiments is mentioned, it is not limited to the particular number or value unless expressly stated otherwise or it is obviously limited to the particular number or value in principle, etc. When the shape, positional relationship, or the like of a component(s) or the like of any of the embodiments is mentioned, it is not limited to the shape, positional relationship, or the like unless explicitly stated otherwise or it is limited to the specific shape, positional relationship, or the like in principle, etc.

What is claimed is:

1. An imaging apparatus comprising:
a receptacle;
a lens that is received in the receptacle and has one surface exposed to an exterior of the receptacle as an exposed surface to capture light from the exterior of the receptacle;
an imager that is disposed within the receptacle and inward of the lens and is configured to capture images of the exterior of the receptacle based on light captured by the lens;
an imager substrate that is disposed within the receptacle and inward of the lens and is configured to control the imager;
a wiper device that includes at least one lens wiper to wipe the exposed surface of the lens, wherein
each of the at least one lens wiper comprises a wiping member that includes a wiper rubber and a wiper blade, and the wiping member is positioned on the exposed surface of the lens in a standby mode, in which mode driving of the wiper device is suspended, thereby partially obstructing the light incident on the lens.

2. The imaging apparatus according to claim 1, wherein
the imager has a rectangular shape with one direction as a longitudinal direction, and
the at least one lens wiper comprises a pair of lens wipers that are aligned along the longitudinal direction of the imager.

3. The imaging apparatus according to claim 1, wherein
the wiper device is driven by a motor, and comprises the motor, a gearbox configured to attenuate rotation of the motor to generate a torque, and a drive shaft which is an output of the gearbox,
the at least one lens wiper is driven based on rotation of the drive shaft, and
the motor, the gearbox, and the drive shaft are arranged in line along an optical axis of the lens.

4. The imaging apparatus according to claim 3, further comprising:
a lens barrel disposed between the lens, the imager, and the imager substrate, and configured to constitute a pathway that directs the light captured by the lens to the imager; and
a lens fixture configured by a separate member from the lens barrel to fix the lens to the lens barrel, the lens fixture having a through hole for inserting the drive shaft therethrough.

5. The imaging apparatus according to claim 4, wherein:
the lens barrel has a male screw thread formed at one end of the lens barrel where the lens fixture is disposed,
the lens fixture has a female screw thread corresponding to the male screw thread formed,
the lens is held between the lens barrel and the lens fixture by fastening the male screw thread and the female screw thread, and
the imaging apparatus further comprises a gasket disposed between the lens fixture and the lens for adjusting thread positions of the male screw thread and the female screw thread in a rotational direction.

6. The imaging apparatus according to claim 1, further comprising:
a wiper cover disposed on an opposite side of the at least one lens wiper from the lens and configured to cover the at least one lens wiper at least partially.

7. The imaging apparatus according to claim 6, wherein
the wiper cover comprises a frame having an opening formed to expose therethrough the lens and the wiping member of the at least one lens wiper, and
in the standby mode, the wiping member is at least partially stowed between the frame and the lens.

8. The imaging apparatus according to claim 7, wherein
the at least one lens wiper comprises a shaft that serves as a rotation center axis around which the wiping member rotates,
the frame has a shaft hole that exposes the shaft, in addition to the opening, and a notch formed between the opening and the shaft hole, and
the wiping member is detachable when the at least one lens wiper is positioned in the notch.

9. The imaging apparatus according to claim 7, wherein
the frame has a drainage hole formed such that a gap between the frame and the lens is in communication with an outward side of the frame.

10. The imaging apparatus according to claim 1, further comprising:
an accessory configured to be powered by a current carrying wire that is withdrawn from the imager substrate to where the lens is disposed, wherein
the wiper device is configured to be driven by a motor, and
the receptacle has an accommodation space formed inside, in which the motor is disposed, and a wiring pathway formed inside, in which the current carrying wire is disposed, with the accommodation space and the wiring pathway being connected.

11. The imaging apparatus according to claim 1, further comprising:
a light source received in the receptacle around the lens and configured to output light towards the exterior of the receptacle, allowing the light to be reflected by an object outside the receptacle and then captured by the lens; and
a guide disposed on one side of the receptacle where the lens is disposed, and configured to cover the light source while allowing light to pass through, wherein
the wiper device comprises, in addition to the at least one lens wiper, a light source wiper configured to wipe a portion of the guide that covers the light source.

12. The imaging apparatus according to claim 1, wherein
in response to detecting a deposit on the exposed surface of the lens based on an imaging result from the imager, the wiper device is automatically actuated to wipe the exposed surface of the lens with the at least one lens wiper.

13. The imaging apparatus according to claim 1, wherein
the imaging apparatus is an on-board camera device for a vehicle.

14. The imaging apparatus according to claim 1, wherein
the at least one lens wiper comprises a pair of lens wipers, and
in a normal position when the imaging apparatus has been installed, a direction in which the pair of the lens wipers are aligned is a horizontal direction.

15. The imaging apparatus according to claim 2, wherein
the wiper device is driven by a motor, and comprises the motor, a gearbox configured to attenuate rotation of the motor to generate a torque, and a drive shaft which is an output of the gearbox,
the at least one lens wiper is driven based on rotation of the drive shaft, and
the motor, the gearbox, and the drive shaft are arranged in line along an optical axis of the lens.

16. The imaging apparatus according to claim 2, further comprising:
a wiper cover disposed on an opposite side of the at least one lens wiper from the lens and configured to cover the at least one lens wiper at least partially.

17. The imaging apparatus according to claim 2, wherein
in response to detecting a deposit on the exposed surface of the lens based on an imaging result from the imager, the wiper device is automatically actuated to wipe the exposed surface of the lens with the at least one lens wiper.

18. The imaging apparatus according to claim 2, wherein
the imaging apparatus is an on-board camera device for a vehicle.

19. The imaging apparatus according to claim 2, wherein
the at least one lens wiper comprises a pair of lens wipers, and
in a normal position when the imaging apparatus has been installed, a direction in which the pair of the lens wipers are aligned is a horizontal direction.

20. The imaging apparatus according to claim 13, wherein
the at least one lens wiper comprises a pair of lens wipers, and
in a normal position when the imaging apparatus has been installed, a direction in which the pair of the lens wipers are aligned is a horizontal direction.
